(19) United States
(12) Patent Application Publication
(10) Pub. No.: US 2004/0043808 A1
(43) Pub. Date: Mar. 4, 2004

(54) Game machine and method of controlling the game machine

(75) Inventors: Akio Niekawa, Tokyo (JP); Norio Tone, Tokyo (JP)

Correspondence Address: SUGHRUE MION, PLLC, 2100 PENNSYLVANIA AVENUE, N.W., WASHINGTON, DC, 20037, US

(73) Assignee: KONAMI CORPORATION

(21) Appl. No.: 10/455,416

(22) Filed: Jun. 6, 2003

(30) Foreign Application Priority Data
Sep. 2, 2002 (JP) P2002-256935

(51) Int. Cl. A63F 13/00

(52) U.S. Cl. 463/13

(57) ABSTRACT

A game machine includes a display which displays a plurality of identification images, each having a numeral image and a symbol image. The symbol image of the identification image is changed at a predetermined opportunity while maintaining a corresponding numeral image of the identification image when a predetermined progression is established among the numeral images of the identification images. Also, sequential numbers among the numeral images of the identification images are changed to another sequential numbers having a beginning number different from a beginning number of the sequential numbers at a predetermined opportunity when the sequential numbers are established among the numeral images of the identification images.

### BACKGROUND OF THE INVENTION

The invention relates to a game machine using cards, each card corresponding to a card image which is a single unit formed by combination of a predetermined numeral image and a predetermined symbol image. Particularly, the invention relates to a game machine to which is added a bonus game for enhancing entertainment value offered to a player and a method of controlling the game machine.

A game machine which allows a player to play a poker game by displaying cards as images has been known. Such a game machine controls a game according to general rules of poker.

Here, a poker game is played as follows. From among five cards displayed as images, a player selects cards to be discarded and those considered necessary.

Generally, the player selects (holds) cards considered necessary, thereby exchanging cards other than those held by the player for new cards, in the hopes of establishing a winning combination.

As shown in FIGS. 10A to 10D, the following four types of hands are mentioned as typical winning combinations arising in a poker game; specifically, a straight (FIG. 10A) in which numeral information about displayed images of five cards indicates, for example “5,” “7,” “6,” “9,” and “8” and the five cards are in consecutive order, such as 5-6-7-8-9; a flush (FIG. 10B) in which five cards share the same symbol information (or symbol images); a straight flush (FIG. 10C) in which the straight and the flush are achieved simultaneously; and a royal flush (FIG. 10D) in which the straight flush is achieved by five cards having numeral information “10,” “J,” “Q,” “K,” and “A.”

The player selects cards to be held, with a view toward establishing such a winning combination. Cards which are not selected and held by the player are exchanged for new cards, and images of the new cards are displayed. The new cards are arbitrarily selected under control of a game machine, and images of the selected cards are displayed.

In this way, images of cards arbitrarily selected under control of the game machine are displayed. One card has a single set formed by combination of one numeral image and one symbol image. Therefore, exchange of one card is synonymous with exchange of at least one of the numeral image and the symbol image.

A card containing a numeral image or a symbol image which is not desired to the player may be displayed by an exchange of cards, thereby disappointing the expectation of the player who desires to establish a winning combination.

Two information items are integrated into a single card. Despite the player's desire to exchange only one of the images (either the numeral image or the symbol image) for a new card, the player runs the risk of two regarding the numeral image and the symbol image being exchanged simultaneously under control of the game machine, thereby disappointing the player's expectation.

### SUMMARY OF THE INVENTION

It is therefore an object of the present invention to provide a game machine having an additional bonus game which enhances the entertainment value offered to the player, by changing only either a numeral image or a symbol image or changing both of them in a stepwise manner, as well as a method of controlling the game machine.

In order to achieve the above object, according to the present invention, there is provided a game machine includes the ability to change a symbol image of an identification image displayed on a display while maintaining a corresponding numeral image, or to change a numeral image while maintaining a corresponding symbol image.

More specifically, the invention provides the following game machines and methods:

A game machine, comprising:

a display, displaying a plurality of identification images, each having a numeral image and a symbol image;

wherein the symbol image of the identification image is changed at a predetermined opportunity while maintaining a corresponding numeral image of the identification image when a predetermined progression is established among the numeral images of the identification images.

A method of controlling a game machine, comprising the steps of:

displaying a plurality of identification images, each having a numeral image and a symbol image; and

changing the symbol image of the identification image at a predetermined opportunity while maintaining a corresponding numeral image of the identification image when a predetermined progression is established among the numeral images of the identification images.

In the above configuration and method, when a predetermined progression is established among numeral images of the identification images, a symbol image of the identification image is changed so as not to disturb the progression while maintaining a corresponding numeral image. Accordingly, when a player desires to change only a symbol images, a change can be made in compliance with the player's will. Therefore, the player can attempt to establish a higher-level winning combination by changing only a symbol image while maintaining a corresponding numeral image, thus enhancing the entertainment value offered to the player.

Preferably, the symbol image of the identification image which is not selected by a player is changed.

In the above configuration, a game machine displaying a plurality of card images can change a symbol image of only the identification image that a player has not selected (a card image other than the held card image). Therefore, a symbol image of the identification image selected by the player (the held card image) is not changed.

Accordingly, the player can select the identification image for which only the symbol image is to be changed. Hence, a change can be made in compliance with the player's will.

A game machine, comprising:

a display, displaying a plurality of identification images, each having a numeral image and a symbol image,

wherein sequential numbers among the numeral images of the identification images are changed to another sequential numbers having a beginning number different from a beginning number of the sequential numbers at a predetermined opportunity when the sequential numbers are established among the numeral images of the identification images.

A method of controlling a game machine, comprising the steps of:

displaying a plurality of identification images, each having a numeral image and a symbol image; and

changing sequential numbers among the numeral images of the identification images to another sequential numbers having a beginning number different from a beginning number of the sequential numbers at a predetermined opportunity when the sequential numbers are established among the numeral images of the identification images.

In the above configuration and method, when the sequential numbers is established among the numeral images of the card images, the sequential numbers can be changed to another sequential numbers without disturbing a set of the sequential numbers established among the numeral images by changing the sequential numbers to the another sequential numbers. Hence, the sequential numbers is changed and displayed so as to become more advantageous to the player, thus enhancing the entertainment value offered to the player.

Here, sequential numbers and another sequential numbers signifies that, provided that a previous sequential numbers is, for example, “1,” “2,” “3,” the another sequential numbers are different from the sequential numbers (e.g., “2,” “3,” “4,” or “9,” “10,” “11”). In terms of progression, two sets of sequential numbers differ from each other with regard to a first term. the another sequential number different from the sequential numbers include sequential numbers differing from each other in terms of common reference and the sequential numbers differing from each other in terms of common ratio, as well as the sequential numbers differing from each other in terms of a first term.

Preferably, the predetermined opportunity is achieved by an automatic control operation of the game machine or when the game machine receives a player's request for change.

The display method for game machine further comprising the step of changing the symbol image of at least one of the identification images at a predetermined opportunity.

In the above configuration and method, the sequential numbers is changed to another sequential numbers, and the changed sequential numbers is displayed. Subsequently, a symbol image belonging to an arbitrary identification image is changed and displayed. Hence, the symbol image can be changed while maintaining a corresponding numeral image.

An identification image for which a symbol image is to be changed may be selected by the player or randomly selected by automatic control operation of the game machine.

A game machine, comprising:

a display, displaying a plurality of identification images, each having a numeral image and a symbol image;

wherein the symbol image of the identification image is changed at a first predetermined opportunity while maintaining a corresponding numeral image of the identification image when sequential numbers are established among the numeral images of the identification images;

wherein the sequential numbers among the numeral images of the identification images are changed to another sequential numbers having a beginning number different from a beginning number of the sequential numbers at a second predetermined opportunity.

A method of controlling a game machine, comprising the steps of:

displaying a plurality of identification images, each having a numeral image and a symbol image;

changing the symbol image of the identification image at a first predetermined opportunity while maintaining a corresponding numeral image of the identification image when sequential numbers are established among the numeral images of the identification images; and

changing the sequential numbers among the numeral images of the identification images to another sequential numbers having a beginning number different from a beginning number of the sequential numbers at a second predetermined opportunity.

In the above configuration and method, stepwise changing of a numeral image and that of a symbol image is established, therefore enhancing entertainment value offered to the player.

The function of the ability to change a symbol image at a predetermined opportunity while maintaining a corresponding numeral image and the function of the ability to change sequential numbers to another sequential numbers can be activated one after the other. Alternatively, there may first be activated the function of the ability to change a symbol image at a predetermined opportunity while maintaining a corresponding numeral image. Subsequently, at a predetermined opportunity, the function of the ability to change a set of sequential numbers to another sequential numbers may be activated. Specifically, in the former case (i.e., the two functions are activated one after the other), one-time occurrence of a predetermined opportunity is preferable. By occurrence of the opportunity, the function of the ability to change a symbol image while maintaining a corresponding numeral image and the function of the ability to change the sequential numbers to the another set of sequential numbers are activated. In the latter case, a predetermined opportunity must occur twice. At the first occurrence of an opportunity, there is activated the function of the ability to change a symbol image while maintaining a corresponding numeral image. At the second occurrence of the opportunity, there is activated the function of the ability to change sequential numbers to another sequential numbers.

Preferably, the first and second predetermined opportunity are achieved by an automatic control operation of the game machine or when the game machine receives a player's request for change.

In the above configuration, the symbol image or the numeral image of the identification image is changed according to either of two patterns: that is, a pattern in which the change is automatically performed by automatic operation of the game machine, and another pattern in which the change is made when a player's request for change is received. An expected result can be sought in compliance with the player's will. Alternatively, a result which would be advantageous to the player can be attained without compliance with the player's will.

A program for causing a computer to function as the above game machine is stored in a computer-readable storage medium or transmitted to the public by way of an electrical communication network.

As shown in FIGS. 4A to 4D, the expression “numeral image” is an image depicting numeral information 122. Integers, such as “1,” “2,” . . . , “12,” “13,” . . . can be mentioned as numeral images. Particularly, in relation to cards, numeral images “A,” “J,” “Q,” and “K” are images respectively depicting numeral information “1,” “11,” “12,” and “13.”

As shown in FIGS. 4A to 4D, the expression “symbol image” is an image depicting a symbol (mark) 121. Symbols such as “Δ,” “□,” and “◯” can be mentioned as the symbol images. Particularly, in relation to cards, the symbol image 121 includes hearts as illustrated in FIG. 4A, diamonds as illustrated in FIG. 4B, spades as illustrated in FIG. 4C, and clubs as illustrated in FIG. 4D.

The expression “identification image” is an image which is a single unit formed by combination of a predetermined numeral image and a symbol image. The identification image includes those shown in FIGS. 4A to 4D. Specifically, the card image 120 is formed from the numeral image 122 and the symbol image 121.

The expression “progression” signifies a relationship in which any one of progressions; that is, an arithmetical progression, a geometric progression, and a difference progression, is established. In particular, in the case of a poker game machine, establishment of an arithmetical progression having a first term of 1 and a common difference of 1; that is, establishment of sequential numbers among numeral images, can be mentioned as a progression.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing the configuration of controller of a game machine according to an embodiment of the invention;

FIG. 2 is a block diagram showing a circuit of a card image generator shown in FIG. 1;

FIG. 3 is a schematic view showing the concept of image data to be generated by the game machine of the embodiment;

FIGS. 4A to 4D are views for describing card images to be displayed on the game machine of the embodiment;

FIGS. 5A to 5E are views for describing changes in symbol images of the card images in the game machine of the embodiment;

FIGS. 6A to 6G are views for describing changes in the numeral images of the card images in the game machine of the embodiment;

FIGS. 7A to 7E are views for describing changes in the symbol images of the identification images and subsequent changes in the numeral images of the same;

FIGS. 8A to 8E are views for describing changes in the numeral images of the identification images and subsequent changes in the symbol images of the same;

FIG. 9 is a flowchart showing flow of information processing to be performed by the game machine of the embodiment; and

FIGS. 10A to 10D are views for describing typical winning combinations in a poker game.

### DETAILED DESCRIPTION OF THE PREFERRED EMBODIMENTS

A game machine according to an embodiment of the invention will be described hereinbelow by reference to the drawings.

[Configuration of a Game Machine]

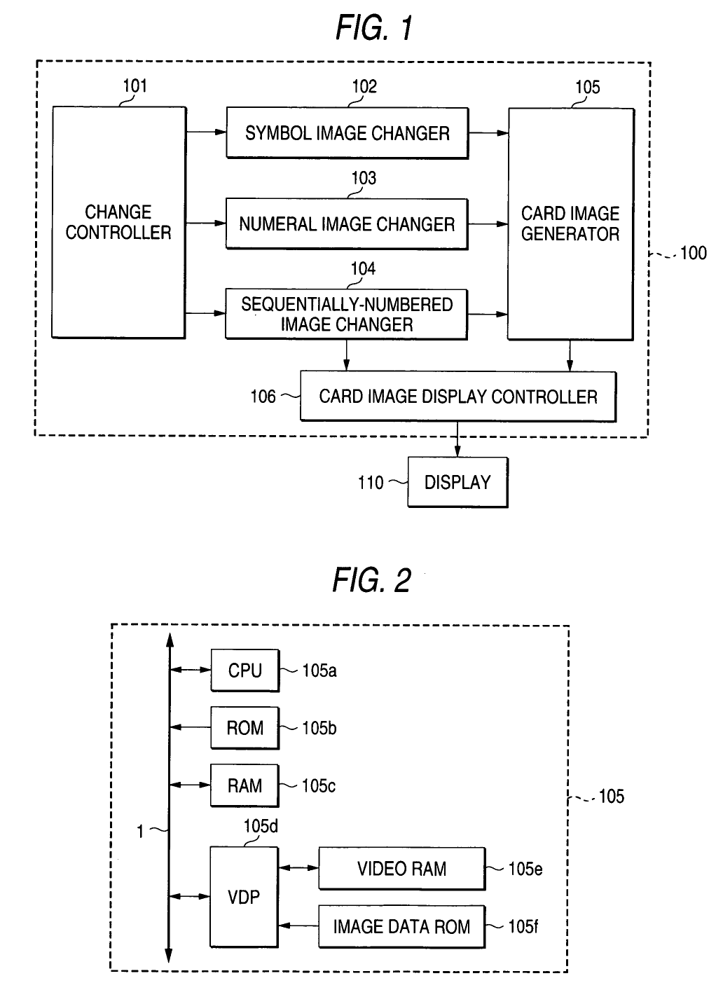

FIG. 1 is a block diagram showing the configuration of controller 100 of a game machine according to an embodiment of the invention.

The controller 100 of the game machine according to the embodiment includes: a change controller 101; a symbol image changer 102; a numeral image changer 103; a sequential-numbered image changer 104; a card image generator 105; and a card image display controller 106. A display 110 has the function of displaying a card image in accordance with an instruction output from the controller 100, the function of displaying a numeral image of the card image after changing it, and the function of displaying a symbol image of the card image after changing it.

Upon receipt of a change request during the course of a game, the change controller 101 sends a change request to the symbol image changer 102 when a symbol image is to be changed; to the numeral image changer 103 when a numeral image is to be changed; and to the sequential-numbered image changer 104 when the level of sequentially-ordered numbers is to be changed. The change request is issued in one of two ways: that is, the change controller 101 sends a signal under automatic control operation of the game machine, and the change controller 101 sends a signal upon receipt of a request for change from the player.

Upon receipt of a signal for changing a symbol image output from the change controller 101, the symbol image changer 102 changes only the symbol image of the card image which is appeared on the display 110. Here, when the symbol image of the card image selected through the player's selecting action is changed or when the symbol image of only the card image which is not selected through the player's selecting action is to be changed, the change controller 101 sends change information about the card image relevant to the change.

Upon receipt of a change signal pertaining to the numeral image from the change controller 101, the numeral image changer 103 changes only the numeral image of the card image which is appeared on the display 110. Here, when the numeral image of the card image selected through the player's selecting action is changed or when the numeral image of only the card image which is not selected through the player's selecting action is changed, the change controller 101 sends change information about the card image relevant to the change.

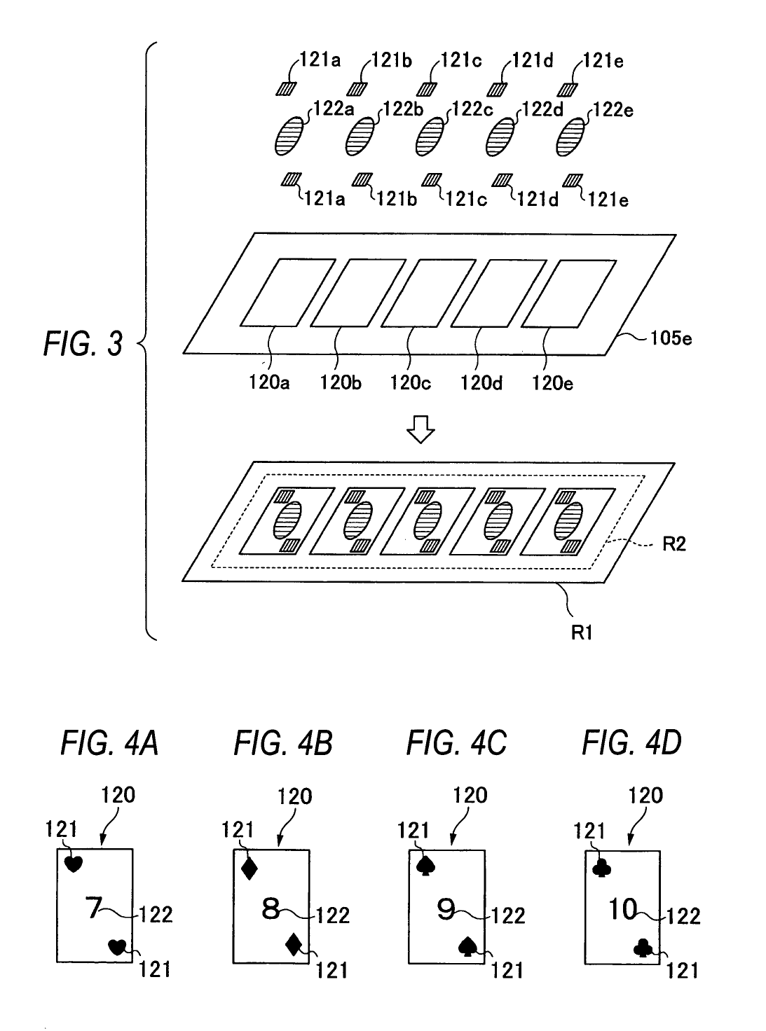

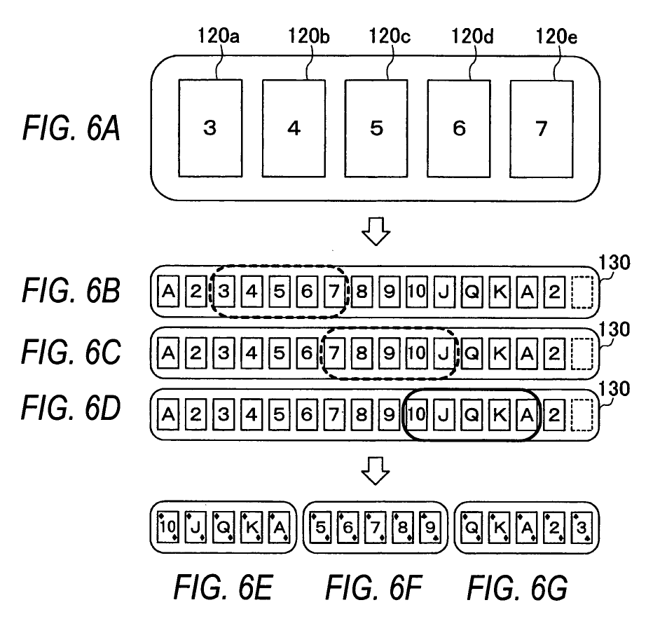

For instance, as shown in FIG. 6B, when a group of card images 130 which is arranged in order are stored in ROM (not shown) of the game machine 1, the sequential-numbered image changer 104 selects, from the group of card images 130, a display region for card images to be displayed as a single set on the display 110. For instance, when a card image having numeral images arranged in order, such as “3,” “4,” “5,” “6,” and “7,” is appeared as a single set on the display 110 (FIGS. 6B-1), the sequential numbers are changed to different sequential numbers beginning with different number from a beginning number of the sequential numbers, whereby a card image having numeral images arranged in order, such as “10,” “J,” “Q,” “K,” and “A,” is displayed as a single set on the display 110, (FIGS. 6B-3). Here, changing of sequential numbers to a different sequential numbers may be performed by temporarily shifting a display region for a card image from among the previously-stored group of card images 130 by only a predetermined number (such as a change from FIGS. 6B-1 to FIGS. 6B-3). Alternatively, changing of sequential numbers may be performed by scrolling a display region for a card image from among the previously-stored group of card images 130 (such as a change from FIGS. 6B-1 to FIGS. 6B-2, and from FIGS. 6B-2 to FIGS. 6B-3).

In accordance with a change instruction issued from the symbol image changer 102, the numeral image changer 103, or the sequential-numbered image changer 104, the card image generator 105 generates a card image 120 displayed on the display 110. The card image 120 generated by the card image generator 105 is displayed on the display 110 by way of a card image display controller 106.

In relation to numeral images and symbol images, a table corresponding to random numbers is prepared beforehand. An card image may be produced by sampling the numeral images and the symbol images through random number generation operation to be performed by the card image generator 105. In this case, the symbol image can be changed while maintaining a corresponding numeral image, by sampling only the symbol image through random number generation operation. Alternatively, the numeral image can be changed while maintaining a corresponding symbol image, by sampling only the numeral image through random number generation operation. Thus, the card image generator 105 can perform the feature of the symbol image changer 102 and that of the numeral image changer 103.

[Generation of Card Image]

By reference to FIGS. 2 and 3, generation of a card image will now be described. Here, FIG. 2 is a block diagram showing a circuit of the card image generator 105. Further, FIG. 3 is a schematic diagram showing the concept of image data to be generated.

The card image generator 105 has a bus 1. The bus 1 is connected to a CPU 105a, ROM 105b, RAM 105c, and a VDP 105d, as well as to individual sections of the controller 100 of the game machine. Image display instructions issued from the individual sections of the controller 100 are supplied to the bus 1 for input/output purposes, where a data signal or an address signal is input to or output from the CPU 105a.

The ROM 105b connected to the bus 1 stores a display control program which generates a drive signal to be supplied to the display 110 in accordance with an image display instruction issued from any of the individual sections of the controller 100. The RAM 105c stores flags and variable numbers to be used by the display control program.

The VDP 105d, serving as an image data processor, includes control circuits, such as a so-called sprite circuit, a screen circuit, and a palette circuit, and performs various processing operations for displaying an image on the display 110.

The VDP 105d is connected to a video RAM 105e for storing image data in accordance with an image display instruction issued from any one of the individual sections of the controller 100, and an image data ROM 105f for storing image data pertaining to a symbol image and image data pertaining to a numeral image.

By loading and executing a display control program stored in the ROM 105b, the CPU 105a stores, into the video RAM 105e, image data to be displayed on the display 110 in accordance with an image display instruction issued from any of the individual sections of the controller 100. The image data stored in the video RAM 105e are displayed on the display 110.

As shown in FIG. 3, image data generated by the video RAM 105e (i.e., an image region R1) are set so as to become larger than a region R2 displayed on the display 110. In FIG. 3, the image region R1 indicates an area enclosed by a solid line, and the display region R2 indicates an area enclosed by broken lines. By such settings, the card image displayed on the display 110 can be smoothly scrolled.

In generation of a card image, the VDP 105d reads, from the image data ROM 105f, an image data pertaining to numeral images 121a to 121e, and image data pertaining to symbol images 122a to 122e, respectively. Subsequently, the read image data are arranged at positions in the video RAM 105e corresponding to locations where the data are to be displayed on the display 110. Image data pertaining to card images 120a to 120e for which neither a symbol image nor a numeral image is set are arranged at respective positions in the video RAM 105e.

In connection with the image data pertaining to the card image generated on the video RAM 105e, only the image data stored in the display region R2 are read from the video RAM 105e.

When only a symbol image or a numeral image from among the card images which is appeared on the display 110 is changed, a symbol image from among symbol images 121a to 121e or a numeral image from among numeral images 122a to 122e, corresponding to the symbol or numeral image to be changed, is overwritten.

[Changing of Symbol Image]

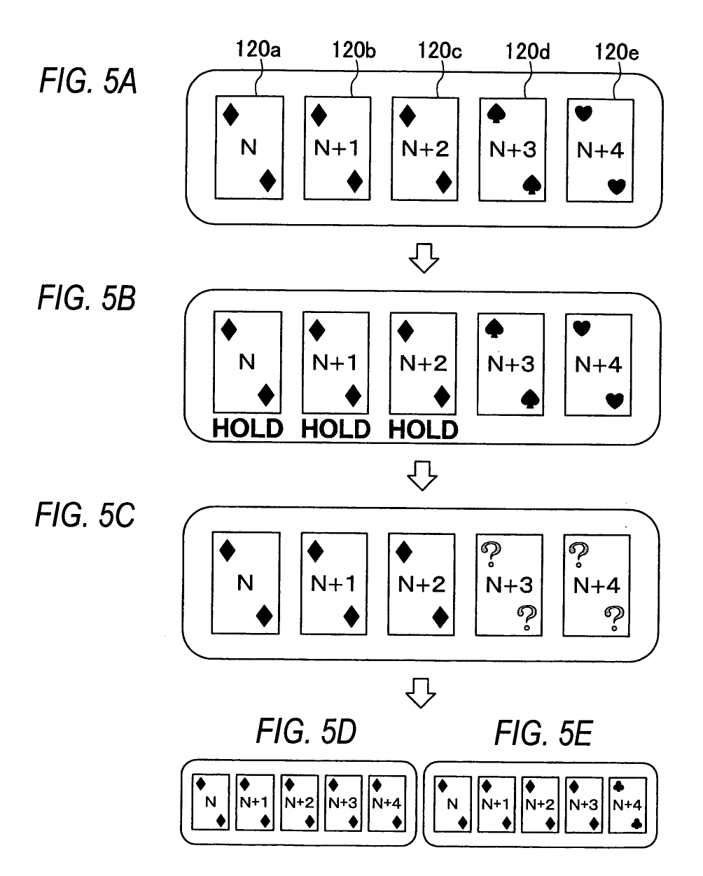

By reference to FIGS. 5A to 5D, changing of a symbol image of the card image will now be described. In FIGS. 5A to 5D, the symbol images 121a to 121e and the numeral images 122a to 122e, all constituting the respective card images 120a to 120e, are the same as those described in connection with FIG. 3, and hence repeated explanations thereof are omitted.

In relation to the card images 120a to 120e appearing as a single set on the display 110, when numerals, which are elements of the numeral images 122a to 122e of the card images 120a to 120e, are arranged in order, to thereby constitute a so-called “straight” (as shown in FIG. 5A), a bonus game which enhances the entertainment value offered to the player is additionally offered.

More specifically, from among the card images 120a to 120e appearing as a single set on the display 110, an arbitrary card image is held as a bonus game. Holding of an arbitrary card image can be performed automatically (under automatic control operation of the game machine) or manually (in accordance with a request for change from the player). In a game machine which displays five card images as a single set, zero to five card images are selected as card images to be held. The player can select card images to be held, through use of hold buttons assigned to the respective card images 120a to 120e provided on the game machine or by touching locations where card images determined to be held are displayed, by way of a touch panel sensor provided on the display 110. As a result, as shown in FIG. 5B, a sign “HOLD” appears at locations corresponding to the card images that is held in this way.

As a result of selection of the card images to be held, symbol images 121d, 121e of the card images (the card images 120d, 120e shown in FIG. 5B) other than the held card images are changed while the corresponding numeral images 122d, 122e are maintained. FIG. 5C shows a state in which the corresponding symbol images 121d, 121e of the card images 120d, 120e are changed randomly.

FIGS. 5D and 5E show results of changing only the symbol images 121d, 121e of the card images 120d, 120e other than the held images 120a to 120c. When, as shown in FIG. 5D, all the symbol images 121a to 121e become identical with each other as a result of changing the symbol images 121d, 121e, a so-called “straight flush” is constituted. Even when, as shown in FIG. 5E, the symbol images 121a to 121d are identical with each other and only the symbol image 121e is different, an ordinary “straight” is constituted.

In this game machine, only the types of symbols of the card images (cards) other than the held card images are randomly changed while the numeral images (i.e., ranks) of the respective cards remain unchanged. Therefore, there is provided an additional bonus game which enables the player to win a winning combination of higher rank, such as the “straight” shown in FIG. 5A being changed to the “straight flush” shown in FIG. 5D (or, under predetermined conditions, to a “royal flush”).

[Changing of Numeral Image]

By reference to FIGS. 6A to 6G, changing of numeral images of card images (changing of sequential numbers to different sequential numbers beginning with different number from a beginning number of the sequential numbers) will now be described. In FIGS. 6A to 6G, the symbol images 121a to 121e and the numeral images 122a to 122e, all constituting the respective card images 120a to 120e, are the same as those described in connection with FIG. 3, and hence repeated explanations thereof are omitted.

In relation to the card images 120a to 120e appearing as a single set on the display 110, when numerals, which are elements of the numeral images 122a to 122e of the card images 120a to 120e, are arranged in order, to thereby constitute a so-called “straight” (as shown in FIG. 6A), a bonus game which enhances the entertainment value offered to the player is additionally offered.

More specifically, the numeral images 122a to 122e of the card images 120a to 120e appearing as a single set on the display 110 are changed in a bonus game. The set of card images for which a sequentially-numbered relationship is established are changed to the different sequential numbers. Changing of the set of sequential numbers to another set of sequential numbers differing from the set of sequential numbers can be performed automatically (under automatic control operation of the game machine) or manually (in accordance with a request for change issued by the player). Upon receipt of the request, a game machine, which displays five card images as a single set, shifts numerals which are elements of the numeral images 122a to 122e.

FIGS. 6B to 6D show states in which a bonus game is automatically or manually started while a “straight,” such as 3-4-5-6-7, is established in the five card images 120a to 120e, to thereby simultaneously scroll all of the five card images by an arbitrary fixed number of frames and have finally been changed to a “royal flush”; that is, “10, “J,” “Q,” “K,” and “A.”

FIGS. 6E, 6F, and 6G show possible results to be obtained as a result of changing the set of sequential numbers to different set of sequential numbers beginning with different number from a beginning number of the set of the sequential numbers. As shown in FIG. 6E, as a result of the set of sequential numbers which is changed to the different set of sequential numbers, the numeral images 122a to 122e assume images “10,” “J,” “Q,” “K,” and “A.” When a flush has already been established, a so-called “royal flush” is established. As shown in FIG. 6F, even when the symbol images 121a to 121d are identical with each other and only the symbol image 121e is different from the others, an ordinary “straight” is established. In contrast, as shown in FIG. 6G, when a straight has already been established and “A” and “2” are included in the numeral images 122a to 122e, the bonus game counts against the player.

Specifically, the game machine offers an additional bonus game which shifts the arrangement of numeral images (i.e., ranks) of the respective cards so as to offer a chance of acquiring a higher-level winning combination.

[Stepwise Changing of Symbol Images and Numeral Images]

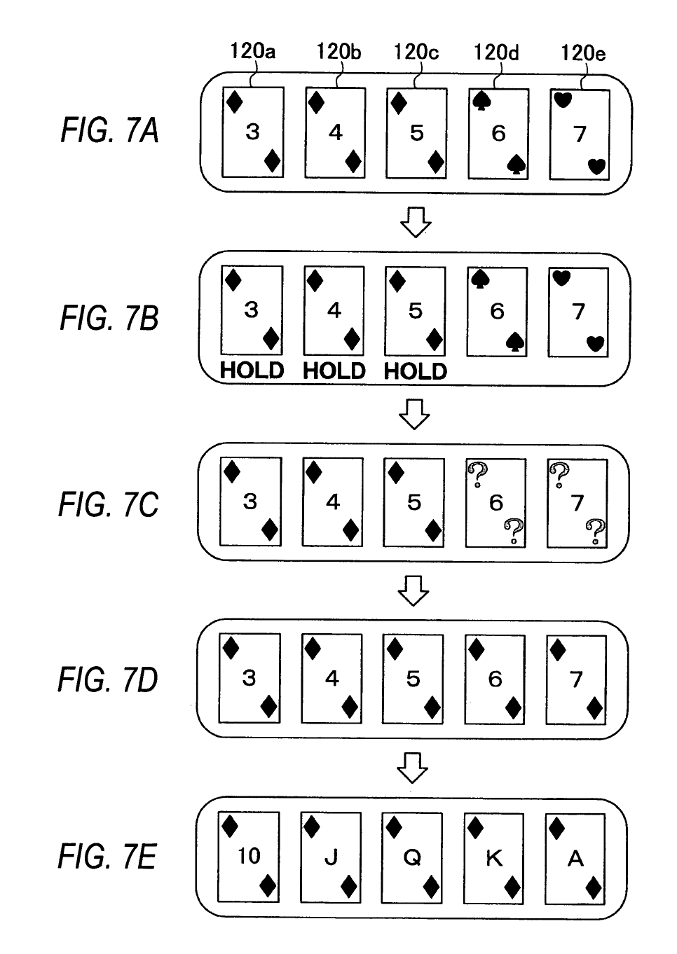

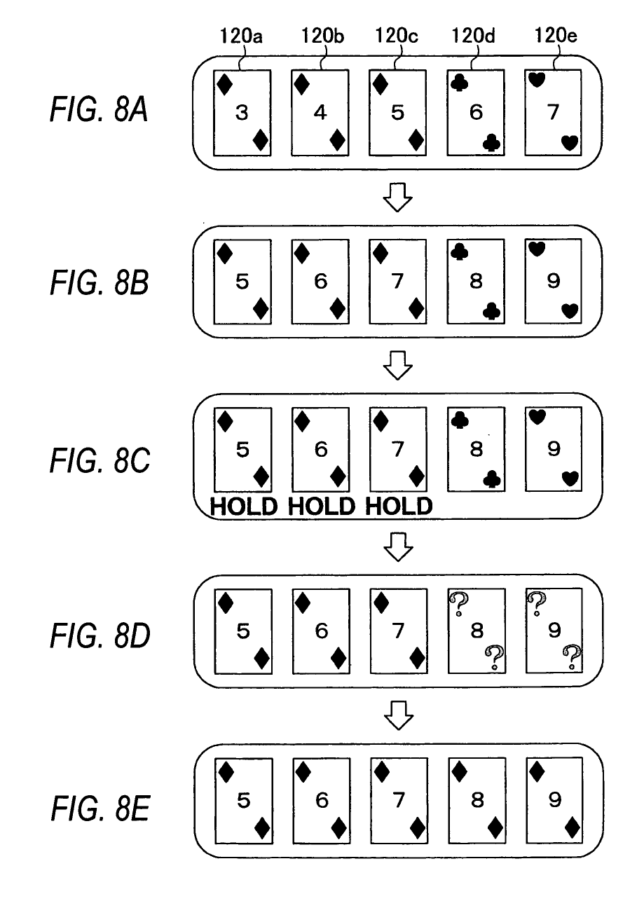

By reference to FIGS. 7A to 8E, the function for changing numeral images and symbol images stepwise will now be described. Here, FIGS. 7A to 7E are views showing that numeral images are changed after changing of symbol images. Basically, the mode shown in FIGS. 7A to 7E is opposite that shown in FIGS. 8A to 8E. More specifically, a mode shown in FIGS. 7A to 7C corresponds to that shown in FIGS. 8C to 8E, and a mode shown in FIGS. 7D and 7E corresponds to that shown in FIGS. 8A and 8B. Although the following description is provided in accordance with the mode shown in FIGS. 8A to 8E, the description can also be applied to that shown in FIGS. 7A to 7E.

FIGS. 8A to 8E are views showing symbol images which are changed after changing of numeral images. More specifically, the drawings illustrate an image display method for a game machine, wherein, when numerals, which are elements of the numeral images of the card images, constitute a set of sequential numbers, the set of sequential numbers is changed to another set of sequential numbers which has a beginning number being different from a beginning number of the set of the sequential numbers at a predetermined opportunity, and the changed set of sequential numbers is displayed. Subsequently, the symbol images are displayed after having been changed while their numeral images are maintained.

First, when numerals serving as elements of the numeral images 121a to 121e of the card images 120a to 120e displayed as a single set on the display 110 are arranged in sequential order and a so-called “straight” is established (FIG. 8A), the game machine offers an additional bonus game which enhances the entertainment value offered to the player.

Specifically, as a bonus game, the numeral images 122a to 122e of the card images 120a to 120e displayed as a single set on the display 110 are changed, thereby changing a set of card images which have already been arranged in a set of sequential numbers to a different set of sequential numbers having a different beginning number from that of the set of sequential numbers. Changing of the set of sequential numbers to the different set of sequential numbers can be performed automatically (under automatic control operation of the game machine) or manually (in accordance with a player's request for change). Upon receipt of the request, a game machine which displays five card images as a single set shifts the numerals serving as elements of the numeral images 122a to 122e.

Symbol images of the card images 120a to 120e which are changed to the different set of sequential numbers (FIG. 8B) are then changed.

At the time of changing of the symbol images, an arbitrary card image from among the card images 120a to 120e displayed as a single set on the display 110 is held. Such holding of images can be performed automatically (under automatic control operation of the game machine) or manually (in accordance with a player's request for change). In the case of a game machine in which five card images are displayed as a single set, zero to five card images are held. Selection of card images to be held is performed by hold buttons assigned to the card images 120a to 120e provided on the game machine. Alternatively, a touch sensor is provided on the display 110 beforehand, and positions of card images to be held are touched. In this way, as shown in FIG. 8C, signs “HOLD” appear at the positions corresponding to the card images to be held.

When cards are dealt after selection of the card images to be held, the symbol images 121d, 121e other than those held (i.e., the card images 120d, 120e shown in FIG. 8C) are changed while their numeral images 122d, 122e are maintained. FIG. 8D is a view showing a state in which the symbol images 121d and 121e of the card images 120d and 120e are randomly changed.

FIG. 8E shows a result of changing, in the manner that, only the symbol images of the card images other than those held. The first winning combination “straight” (FIG. 8A) has been shifted to a higher level; that is, to “straight flush.” Thus, addition of a bonus game enhances the entertainment value offered to the player.

A game machine which changes numeral and symbol images stepwise may be arranged so as to automatically (under automatic control operation of the game machine) or manually (according to selection by the player) select whether to change symbol images or numeral images.

[Flow of Information Processing]

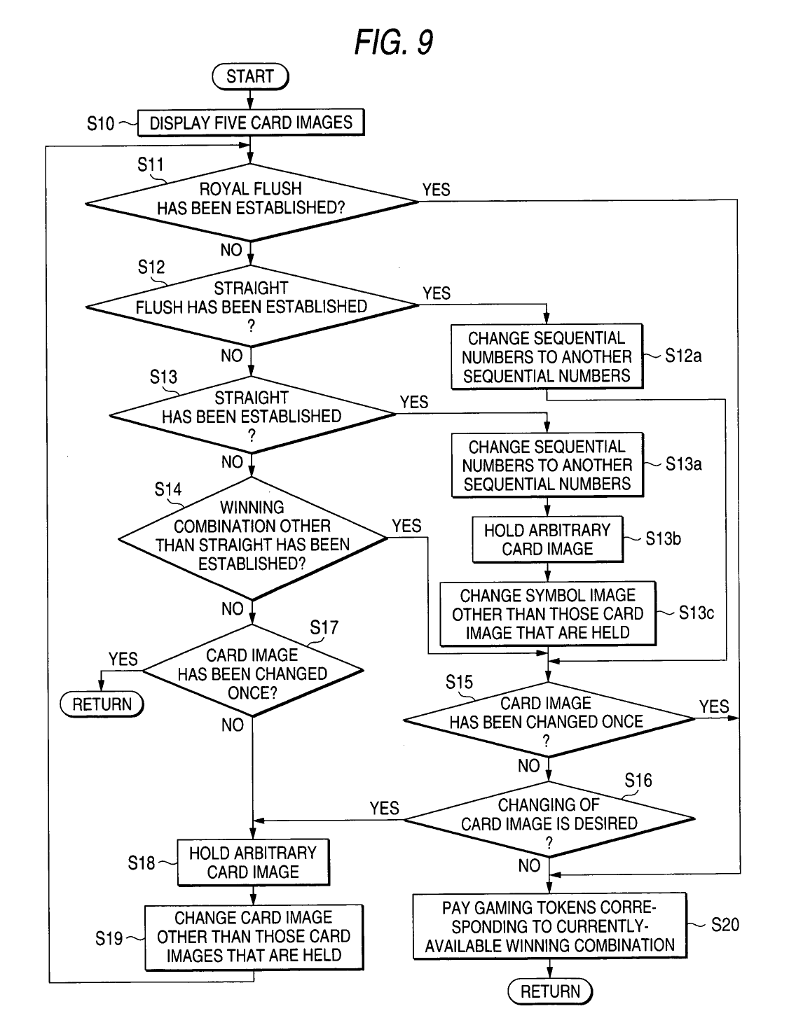

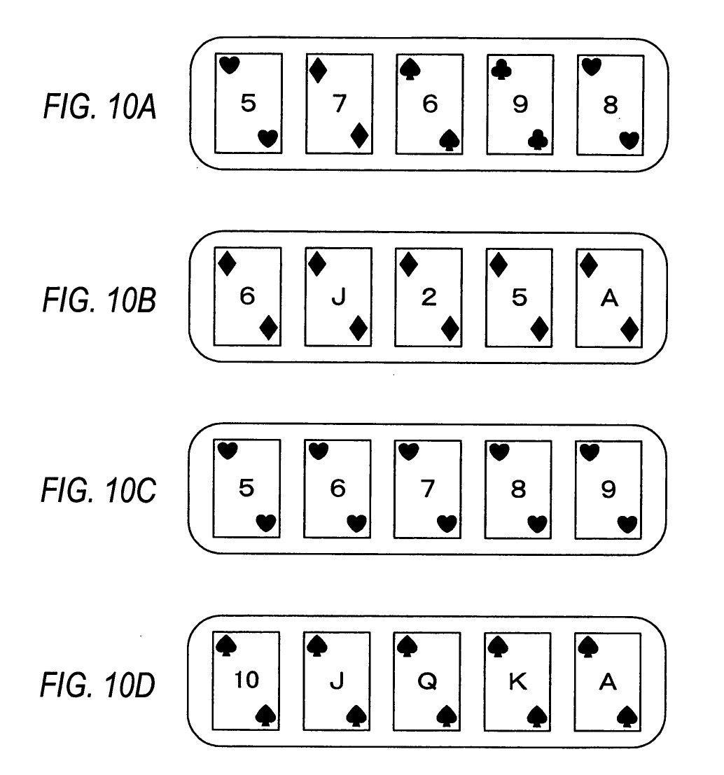

FIG. 9 is a flowchart showing flow of information processing to be performed by the game machine of the embodiment.

Hereinbelow, the flowchart will be used to describe flow of information processing to be performed by the game machine of the embodiment when the player plays a so-called draw poker game.

When the player inserts a predetermined number of gaming tokens into the game machine, a display control program for producing a drive signal to be supplied to the display 110 is invoked from the ROM 105b, whereupon five card images are displayed on the display 110 (S10).

In connection with the five card images appearing on the display 10, a determination is made as to whether or not a so-called “royal flush” has been established (S11). When the “royal flush” is determined to have been established, gaming tokens corresponding to the rank of the winning combination are paid (S20), because the winning combination of highest rank has been established. The sub-routine is now completed.

When in step S11 a so-called “royal flush” is determined not to have been established, a determination is made as to whether or not a so-called “straight flush” has been established in connection with the five card images appearing on the display 10 (S12). When the so-called “straight flush” has been established, the change controller 101 instructs the numeral image changer 103 to change a numeral image; that is, to change a set of sequential numbers to different set of sequential numbers, thus effecting the change (S12a). Changing of a set of sequential numbers to a different set of sequential numbers may be performed through, e.g., random number generation operation using a random number table.

Processing proceeds to step S15, and, in the case where changing of a card image is determined not to have been performed at all, a determination is made as to whether or not changing of a card image is desired (S16). When no desire to change is determined, gaming tokens corresponding to a currently-available winning combination are paid (S20). The sub-routine is now completed.

When in step S16 desire to change a card image is determined, processing for holding an arbitrary card images is performed for changing a card image (S18).

If in step S12 a so-called “straight flush” is determined not to have been established, a determination is made as to whether or not five card images appearing on the display 10 constitute a so-called “straight” (S13). When establishment of the “straight flush” is determined, changing similar to the previously-described change (S12a) is performed (S13a). The player holds an arbitrary card image, and information about the held image is transmitted to the game machine (S13b). The change controller 101 instructs the symbol image changer 102 to change a symbol image, thus changing the symbol image (S13c).

Subsequently, the foregoing determination processing is performed (S15, S16), and gaming tokens corresponding to a currently-available winning combination are paid (S20). The sub-routine is now completed. Alternatively, processing for changing a card image is performed (S18).

If in step S13 the “straight” is determined not to have been established, a determination is made as to whether any winning combination other than a so-called “straight” has been established in connection with the five card images appearing on the display 110; that is, whether or not any winning combination at all has been established(S14). When establishment of a winning combination other than the so-called “straight” is determined, the determination processing set forth is performed (S15, S16). Gaming tokens corresponding to a currently-available winning combination are paid (S20). The sub-routine is now completed; otherwise, processing for changing a card image is performed (S18).

When in step S14 a winning combination other than the so-called “straight” is determined not to have been established; that is, when no winning combination is determined to have been established, a determination is made as to whether or not changing of a card image has been performed at least once (S17). If changing of a card image has been performed once, the sub-routine is terminated. In contrast, if in step S17 changing of a card image is determined to have never been performed, the player holds an arbitrary card image, and processing for transmitting information about the thus-held image to the game machine is performed (S18). The change controller 101 instructs the symbol image changer 102 and the numeral image changer 103 to change a card image, thus changing the card image (S19).

Processing is now returned to processing pertaining to step S11, and the foregoing processing is started again.

The descriptions about flow of information processing have employed an example in which determination processing is caused to proceed in sequence, such as step S11, step S12, step S13, and step S14. However, the invention is not limited to such an example, and determination processing may be started from any step.

What is claimed is:

1. A game machine, comprising:
a display, displaying a plurality of identification images, each having a numeral image and a symbol image,
wherein the symbol image of the identification image is changed at a predetermined opportunity while maintaining a numeral image in the identification image when a predetermined relation is established among the numeral images of the identification images.

2. The game machine as set forth in claim 1, wherein the symbol image of the identification image which is not selected by a player is changed.

3. The game machine as set forth in claim 1, wherein the predetermined opportunity is achieved by an automatic control operation of the game machine or when the game machine receives a player's request for change.

4. A game machine, comprising:
a display, displaying a plurality of identification images, each having a numeral image and a symbol image,
wherein sequential numbers among the numeral images of the identification images are changed to another sequential numbers having a beginning number different from a beginning number of the sequential numbers at a predetermined opportunity when the sequential numbers are established among the numeral images of the identification images.

5. The game machine as set forth in claim 4, wherein the symbol image of at least one of the identification images is changed at a predetermined opportunity after the sequential numbers are changed to the another sequential numbers.

6. The game machine as set forth in claim 4, wherein the predetermined opportunity is achieved by an automatic control operation of the game machine or when the game machine receives a player's request for change.

7. A game machine, comprising:
a display, displaying a plurality of identification images, each having a numeral image and a symbol image;
wherein the symbol image of the identification image is changed at a first predetermined opportunity while maintaining a numeral image in the identification image when sequential numbers are established among the numeral images of the identification images;
wherein the sequential numbers among the numeral images of the identification images are changed to another sequential numbers having a beginning number different from a beginning number of the sequential numbers at a second predetermined opportunity.

8. The game machine as set forth in claim 7, wherein the first predetermined opportunity and the second predetermined opportunity are the identical.

9. The game machine as set forth in claim 7, wherein the first and second predetermined opportunity are achieved by an automatic control operation of the game machine or when the game machine receives a player's request for change.

10. A method of controlling a game machine, comprising the steps of:
displaying a plurality of identification images, each having a numeral image and a symbol image; and
changing the symbol image of the identification image at a predetermined opportunity while maintaining a numeral image in the identification image when a predetermined relation is established among the numeral images of the identification images.

11. A method of controlling a game machine, comprising the steps of:
displaying a plurality of identification images, each having a numeral image and a symbol image; and
changing sequential numbers among the numeral images of the identification images to another sequential numbers having a beginning number different from a beginning number of the sequential numbers at a predetermined opportunity when the sequential numbers are established among the numeral images of the identification images.

12. The method as set forth in claim 11, further comprising the step of changing the symbol image of at least one of the identification images at a predetermined opportunity.

13. A method of controlling a game machine, comprising the steps of:
displaying a plurality of identification images, each having a numeral image and a symbol image;
changing the symbol image of the identification image at a first predetermined opportunity while maintaining a numeral image in the identification image when sequential numbers are established among the numeral images of the identification images; and
changing the sequential numbers among the numeral images of the identification images to another sequential numbers having a beginning number different from a beginning number of the sequential numbers at a second predetermined opportunity.

14. The game machine as set forth in claim 13, wherein the first predetermined opportunity and the second predetermined opportunity are the identical.
